(19) United States
(12) Patent Application Publication
(10) Pub. No.: US 2023/0255216 A1
(43) Pub. Date: Aug. 17, 2023

(54) WHEAT-CONTAINING FLOUR AND DOUGH WITH PEA PROTEIN

(71) Applicant: CARAVAN INGREDIENTS INC., Lenexa, KS (US)

(72) Inventors: Juliana DINIZ FARIA, Gorinchem (NL); Ivan Guilherme DE BARROS ABRAÃO DE SOUZA, Gorinchem (NL); Paola Maria LOPES DA SILVA, Gorinchem (NL)

(73) Assignee: CARAVAN INGREDIENTS INC., Lenexa, KS (US)

(21) Appl. No.: 18/019,394

(22) PCT Filed: Aug. 7, 2020
(86) PCT No.: PCT/EP2020/072313

§ 371 Date: Feb. 2, 2023

(51) Int. Cl. A21D 2/26; A21D 10/00; A21D 13/40; A21D 8/04

(52) U.S. Cl. CPC A21D 2/266; A21D 8/042; A21D 10/005; A21D 10/007; A21D 13/40

(57) ABSTRACT

A possibility to enhance the action of transglutaminase by helping the formation of peptide bonds with the glutamine present in the wheat flour, directed to a bakery pre-mix composition including pea protein and transglutaminase and a carrier, and a flour formulation including wheat flour, transglutaminase and pea protein. It was found that with the flour formulation a dough could be prepared with an improved process tolerance. The baked products prepared by baking the dough were found to have an improved crumb structure.

### FIELD

The present invention is directed to a wheat-containing flour formulation comprising pea protein, a dough prepared thereof, and a baked product such as bread obtained by baking the dough and methods for preparing the dough and the baked product.

### BACKGROUND

Bread is one of the oldest biotechnological products. Wheat is by far the most important cereal in breadmaking. In wheat breadmaking, flour, water, salt, yeast or other micro-organisms and optional ingredients such as sugar and fat, are mixed into a viscoelastic dough, which is fermented and baked. Yeast-leavened breads are widely consumed and appreciated by consumers because of its characteristics such as volume, crumb properties and taste. The ability of wheat proteins to develop a viscoelastic matrix is what makes wheat the most appropriate cereal for breadmaking. The viscoelastic matrix is able to retain the gas produced during fermentation, yielding an aerated crumb bread structure.

Despite the high ability of wheat to develop a viscoelastic matrix, other ingredients may be added to further increase the bread structure. Such other ingredients may be enzymes, oxidizing and reducing agents, gums, emulsifiers etc. An example of such an enzyme is transglutaminase. The use of transglutaminase in wheat-containing bread is known. Also the use of transglutaminase in other types of flours such as barley or soy flour or blends thereof is known.

For instance, the general use of transglutaminase in wheat was described in EP 0492406.

EP 0492406 relates to an improvement in the field of baking technology, more particularly to leavened doughs and bakery products prepared from these leavened doughs. In this publication the use of transglutaminase for leavened baked goods is described. Optionally the enzyme is combined with a protease or ascorbic acid. It is said to improve the resistance of the dough to stretching by crosslinking the gluten protein in the wheat. The transglutaminase is used in an amount varying from hundred to 10,000 units per kilogram of flour.

US 6517874 describes to make use of transglutaminase to produce bread with a relatively low wheat content. It refers to the above described EP publication and restricts the wheat content to up to 50%. It discloses that the bread further contains non-wheat flours. The non-wheat flour can be any type of flour which on its own does not possess any or only insufficient baking properties. Examples are oat flour, barley flour, maize flour, buckwheat flour, millet flour, rye flour, amaranth flour, quinoa flour and other non-cereal flowers of plant origin, such as potato flour, soybean flour or leguminous plant flour. No further examples of leguminous plant flour are given. The publication is further mainly directed to the combination of wheat flour and rye.

In H.J. Ahn’s “Functional and thermal properties of wheat, barley, and soy flours and their blends treated with microbial transglutaminase (MTG)”, J Food Sci 2005 70(6) c380-c386, the effects of MTG treatment of the various flours is described.

A.Bonet’s “Formation of homopolymers and heteropolymers between wheat flour and several protein sources by transglutaminase-catalyzed crosslinking” Cereal chemistry 2006 V83(6) 665-662 studies the influence of the addition of different protein sources on wheat dough functionality. Especially, the possibility of forming heteropolymers between the wheat and the other protein sources by the transglutaminase was investigated. To this end a blend of wheat and 20% w/w of soy, gelatin, albumin, lupin and beer proteins, respectively, was used for the preparation of a dough and the wheat gluten quality, the hardness of the dough and the stickiness of the dough was tested. It was concluded that with the exception of egg proteins, the presence of the different protein sources resulted in a significant increase in the time required to reach the minimum torque. It was further concluded that from all protein sources assessed, only doughs made up with lupin flour seem to form heteropolymers with the wheat in the presence of transglutaminase.

### SUMMARY

The present disclosure provides a possibility to enhance the action of transglutaminase by helping the formation of peptide bonds with the glutamine present in the gluten in wheat flour.

To this end the present disclosure is directed to a bakery pre-mix composition comprising transglutaminase, pea protein and a carrier material. In said bakery pre-mix composition the amount of carrier material may range from 5 to 99.99% w/w, based on the total weight of the bakery pre-mix composition.

The carrier material may comprise material selected from the group of cornstarch, maize flour, rice flour, potato starch, cassava starch, wheat flour, maltodextrin, tricalcium phosphate (TCP), salt, calcium carbonate and silica or combinations thereof.

The amount of pea protein may range from 500 ppm to 95% w/w, preferably 2500 ppm to 80% w/w, most preferably form 5000 ppm to 50% w/w, based on the total weight of the bakery pre-mix composition.

The amount of transglutaminase ranges from 0.05 to 5 TGU/g, preferably 0.1 to 2 TGU/g and most preferably from 0.15-0.5 TGU/g based on the total weight of the bakery pre-mix composition.

The bakery pre-mix composition may suitably be mixed with flour to form a flour formulation. In the flour formulation the bakery pre-mix composition may be present in an amount ranging from 0.01 to 20% w/w, based on the total weight of flour formulation.

In an embodiment the disclosure is directed to a flour formulation comprising wheat flour, transglutaminase and pea protein.

In the flour formulation the amount of transglutaminase may vary from 0.05 to 0.5 TGU, preferably 0.1 to 0.4 TGU and most preferably from 0.15 to 0.3, per 100 grams of flour in the total flour formulation.

The amount of pea protein in the flour formulation may vary from 100 ppm to 10.000 ppm, preferably 500 to 5.000 ppm, most preferably form 1.000 to 2.000 ppm, based on the weight of flour in the flour formulation.

The amount of wheat flour in the formulation may vary from 1 to 99.99 % w/w, preferably 10 to 99.9% w/w, more preferably 50 to 99.9% w/w, most preferably 70 to 99.9% w/w, based on the total weight of the flour formulation.

In one aspect the disclosure is directed to a dough composition comprising the flour formulation as described above. Said dough composition may comprise a liquid such as water and/or milk. In addition to the liquid the dough may comprise fat, oil, butter, sugar and/or egg.

The dough may be prepared by combining a flour formulation as described above with a liquid to form a mixture and said mixture is intimately mixed to form a dough. Optionally, fat, oil, butter, sugar and/or egg is added and intimately mixed to form a dough.

In a further aspect a baked product is prepared by leavening a dough composition according to the disclosure and baking the leavened dough to form a baked product.

The present disclosure is also directed to a baked product obtainable by the method described above, such as bread.

The use of pea protein to provide gluten-free baked products has been described.

M. Dube’s “Texturisation and modification of vegetable proteins for food applications using microbial transglutaminase”, Eur Food Res Techn June 2006, gives an overview of the various applications of transglutaminase for the production of plant protein-based food products such as tofu, bread and bakery products. The possibility of the utilization of novel proteins such as pea, lupine, sesame and sunflower as functional ingredients is investigated, with particular focus on the suitability of these novel plant protein sources to be cross-linked with microbial transglutaminase. It was concluded that protein from leguminous plants is a rather poor substrate for microbial transglutaminase.

Further several publications were found related to the use of vegetable proteins in dairy substitute products such as yoghurt, sour cream, and cheese.

### DETAILED DESCRIPTION

The present disclosure provides a possibility to enhance the action of transglutaminase by helping the formation of peptide bonds with the glutamine present in the wheat flour.

To this end the present disclosure is directed to a bakery pre-mix composition comprising pea protein, transglutaminase and a carrier material. With said bakery pre-mix composition a flour formulation comprising wheat flour, transglutaminase and pea protein may be prepared. The flour formulation may also be prepared by directly adding the pea protein and the transglutaminase to the flour to form a flour formulation. It was found that with the flour formulation a dough could be prepared with an improved process tolerance. The baked products prepared by baking the dough were found to have an improved crumb structure.

In the bakery pre-mix composition the amount of carrier material may range from 5 to 99.99% w/w, based on the total weight of the bakery pre-mix composition. A carrier material is added to the pea protein and transglutaminase to provide volume so as to increase the handling properties of the resulting bakery pre-mix composition.

The carrier material may comprise material selected from the group of cornstarch, maize flour, rice flour, potato starch, cassava starch, wheat flour, maltodextrin, tricalcium phosphate (TCP), salt, calcium carbonate and silica or combinations thereof.

These materials are suitable for use in baking products and do not detrimentally affect the structural properties of the final product.

The amount of pea protein in the bakery pre-mix composition may range from 500 ppm to 95% w/w, preferably 2500 ppm to 80% w/w, most preferably form 5000 ppm to 50% w/w, based on the total weight of the bakery pre-mix composition. This is dependent on the amount of bakery pre-mix composition that will be used in the flour formulation and the final baking application that is envisaged.

The amount of transglutaminase in the bakery pre-mix composition ranges from 0.05 to 5 TGU/g, preferably 0.1 to 2 TGU/g and most preferably from 0.15 to 0.5 TGU/g based on the total weight of the bakery pre-mix composition.

The bakery pre-mix composition may suitably be mixed with flour to form a flour formulation. In the flour formulation the bakery pre-mix composition may be present in an amount ranging from 0.01 to 20% w/w, based on the total weight of flour formulation.

The flour formulation may also be formed directly from the separate ingredients, i.e. by combining wheat flour, transglutaminase, pea protein and optionally other ingredients.

Transglutaminase [EC 2.3.2.13] is a commercially available enzyme that is also sold for bakery applications. It is used to enforce the gluten network in the dough. For the purpose of the present disclosure any commercially available transglutaminase for baking products can be used.

The amount of transglutaminase In the flour formulation may vary from 0.05 to 0.5 TGU, preferably 0.1 to 0.4 TGU and most preferably from 0.15 to 0.3 TGU, per 100 grams of flour in the total flour formulation.

The amount of transglutaminase preparation needed is dependent on its activity. Enzyme suppliers usually define the activity of their transglutaminase preparations in terms of transglutaminase units per gram enzyme preparation.

The transglutaminase activity of an enzyme preparation may be determined by the colorimetric hydroxamate test with hydroxylamine as the substrate. 1 TGU / g is defined as the amount of enzyme preparation that releases 1 pmole of hydroxyaminic acid per minute under standardized conditions, at 37° C. and pH 6.0 with 0.2 M Tris-HCl buffer (EP1190624B1).

Pea protein, or sometimes called pea protein isolate, is a product that is normally isolated from peas by means of either dry or wet milling. Preferably yellow peas are used for the preparation of pea protein isolate, but also other types of peas may be used such as green peas, chick peas, garden peas. The pea protein is commercially available and is normally used in dietary gluten-free products. The amount of pea protein in the flour formulation may vary from 100 ppm to 10000 ppm, preferably 500 to 5000 ppm, most preferably form 1000 to 2000 ppm, based on the total weight of the flour in the flour formulation. The amount of protein in the pea protein product usually varies between 50 to 100 % w/w.

Part of the pea protein may be replaced by a vegetal protein source selected from the group of flaxseed, rice, beans, soy bean, white bean, cranberry bean, kidney bean, black bean, navy bean, pinto bean, lima bean, mung bean, chia seeds, fava bean, lentil, lupine, wheat, granola, potato and hemp or combinations thereof. The vegetal protein source is preferably from legumes. More preferably, the vegetal protein source is from beans. In some cases even all of the pea protein may be replaced with the vegetal protein sources mentioned above. The amount of vegetal protein source to be added may be such that equal amounts of protein are applied. The amount of protein from vegetal protein sources selected from the group of pea, flaxseed, rice, beans, soy bean, white bean, cranberry bean, kidney bean, black bean, navy bean, pinto bean, lima bean, mung bean, chia seeds, fava bean, lentil, lupine, wheat, granola, potato and hemp or combinations thereof in the flour formulation may vary from 50 ppm to 10000 ppm, preferably 2500 to 5000 ppm, most preferably form 500 to 2000 ppm, based on the total weight of the flour in the flour formulation.

The flour formulation according to the disclosure mainly comprises wheat flour, but also other types of flour may be present such as oat flour, barley flour, maize flour, buckwheat flour, millet flour, rye flour, amaranth flour, quinoa flour and other non-cereal flowers of plant origin, such as potato flour, soybean flour or leguminous plant flour. The most common flour present in addition to the wheat is rye. The amount of wheat flour in the flour formulation varies from 1 to 99.99 % w/w, preferably 10 to 99.9 % w/w, more preferably 50 to 99.9 % w/w, most preferably 70 to 99.9 % w/w.

In addition to transglutaminase, wheat flour, pea protein and optionally additional non-wheat flour, the flour formulation may comprise other conventional bakery ingredients such as salt, other enzymes such as amylases, cellulases, lipases, glucose oxidases, hexose oxidases and hemicellulases, bread improver, emulsifiers, sugar, vegetable flour, cereal flour, malt, ascorbic acid. These additional bakery ingredients may also be added partly or fully to the bakery pre-mix composition when desired.

When preparing a dough composition with the flour formulation according to the disclosure a liquid is added to form a mixture and said mixture is intimately mixed to form a dough. Depending on the final baked product said liquid may be water, milk or egg, egg white or egg yolk or any other liquid dairy product. Water and/or milk is preferred. In addition to the liquid, fat, oil, butter, seeds, dried fruit and/or egg powder may be added and intimately mixed to form a dough. Also leavening agents may be added such as yeast, baking soda, sourdough or leaven. Within the context of the present description the term “dough” refers to any flour formulation according to the description wherein an amount of liquid has been added. It thus also includes batters, creams, foams etcetera.

In a further aspect a baked product is prepared by optionally leavening a dough composition according to the disclosure, and baking to form a baked product. Examples of baked products are bread, flat bread, bread rolls, pastry, puffed pastry, cake, cookies.

The present disclosure is also directed to a baked product obtainable by the method described above, such as bread.

The present invention is further illustrated by means of the following examples. These examples merely function to illustrate the invention and by no means can be construed as being limitative.

### EXAMPLES

### Materials

The experiments have been performed with whole grain flour. The main characteristics of the flour are listed below

| | |
|---|---|
| Ashes dry basis (% w/w) | 1.57 |
| Fatty acids (% w/w | 58.21 |
| Falling Number | 389 |
| Dry gluten (% w/w) | 8.7 |
| Damaged starch (% w/w) | 7.29 |
| Passing through 80 mesh (% w/w) | 80.3 |

### Methods

### Rheological Analysis

The rheological analysis of the dough was carried out based on measurements according to the Chopin+ protocol on the Mixolab (ICC173 or AACC 54-60.01). In this method the torque of the mixing process is measured during a cycle of heating and cooling of the dough. The method provides insight in the behavior of the full flour formulation.

The main parameters that are taken into consideration are the curve peaks C1 and C2 and its time of happening and the CS.

The equipment measures the dough consistency at different moments, beginning with the addition of water, following 8 minutes of mixing for dough development, following a heating process and ending with a cooling process.

C1 is the maximum torque obtained in the mixing process within the first 8 minutes, and it indicates the dough development, being highly dependent of the absorption and liberation of water provided by the activated flour.

CS is the torque at the end of 8 minutes, the moment the dough is going to start being heated, indicating the dough consistency after it has been developed. Higher levels of CS means the dough maintained its stability during mixing time, indicating better gluten formation.

C2 is the lowest point the curve reaches the moment the heating takes place, diminishing the consistence, and before it gains consistency back when the starch begins its gelatinization process. That parameter indicates the gluten resistance to heating, being that, higher the value of C2, higher is the gluten resistance.

The texture of the resulting bread was analyzed by means of a texturometry test (according to AACC 74-09 standard test). The tests were performed 6 times using 6 different slices of each bread, the mean value of each test is presented next to a Tuckey’s test with 95% of significance.

### Example 1: Rheological Analysis

Various doughs were prepared having varying amounts of transglutaminase (TGA, Veron TG®, AB Enzymes) and pea protein (NUTRALYS® S85XF, Roquette). The dough consistency was determined by measuring the torque over time. The TGA and pea protein content in the different tests is provided in Table 1.

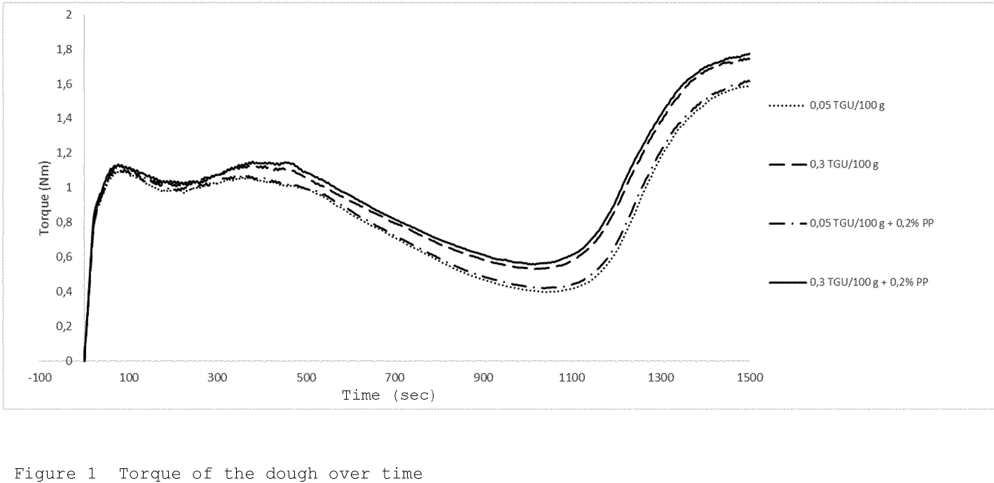

TABLE 1

| Test Number | Transglutaminase (TGU/100 g flour) | Pea Protein (ppm flour based) | Curve in FIG. 1 |
|---|---|---|---|
| 1 | 0.05 | 0 | Dotted line |
| 2 | 0.30 | 0 | Traced line |
| 3 | 0.05 | 2000 | Trace-dot line |
| 4 | 0.30 | 2000 | Continuous line |

The resulting curves for tests numbers 1 to 4 have been depicted in FIG. 1.

The curves in FIG. 1 show that higher doses of TGA enhance the gluten resistance to heat, lifting up the curves on the lowest point, and that the addition of pea protein acts in synergy with the TGA, adding extra resistance to the gluten.

### Example 2: Application Tests

Application tests in industrial bread were made using the recipe given in Table 2.

TABLE 2

Application tests recipe

| Ingredient | Commercial name/supplier | Dose (% w/w flour based) |
|---|---|---|
| Whole grain wheat flour | N.A. | 100 |
| Fresh yeast | ex AB Mauri | 3.5 |
| Salt | N.A. | 1.8 |
| Soy oil | Liza - ex Cargill Group | 3 |
| Brown sugar | N.A. | 8 |
| Vinager | ex Castelo Alimentos Vinhagre Castelo | 2 |
| Calcium propionate | ex AB Mauri | 0.4 |
| Vital wheat gluten | ex Meelunie | 17 |
| Dough conditioning enzyme blend | Pristine 5500 VF (ex Corbion) | 0.3 |

The levels chosen for the DOE relate to the recipe in Table 2. TGA varies from zero to 0.25 TGU/100 g of flour and the pea protein varies from zero to 500 ppm (flour based). That way it is possible to evaluate the isolated effects of each ingredient in the formula in addition to its combined effects.

TABLE 3

DOE levels for the application tests

| | TGA (TGU per 100 g flour) | Pea protein (ppm flour based) |
|---|---|---|
| Test 1 | 0 (-) | 0 (-) |
| Test 2 | 0.25 (+) | 0 (-) |
| Test 3 | 0 (-) | 500 (+) |
| Test 4 | 0.25 (+) | 500 (+) |

The process conditions during dough preparation were varied as presented in Table 4 in order to investigate the process tolerance of the various compositions.

TABLE 4

Process conditions in the application tests

| | | | |
|---|---|---|---|
| | Mixing time | Fermentation time | Mechanical shock |
| Average | 9 min | 1 h | No |
| Undermixed | 7 min | 1 h | No |
| Overmixed | 11 min | 1 h | No |
| Overfermented | 9 min | 1 h30 | No |
| Mechanical shock | 9 min | 1 h | Yes |

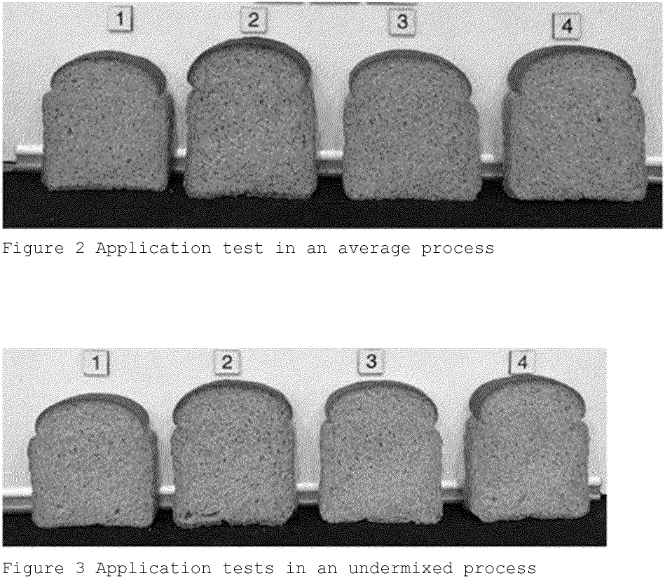

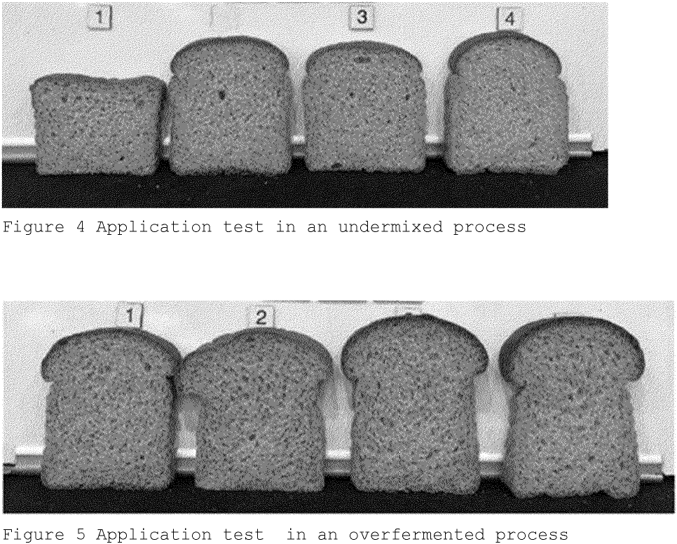

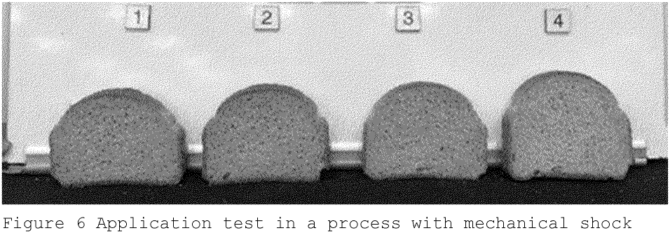

Photos of the resulting breads are provided in FIGS. 2-6. Texturometry results are provided in Table 5.

TABLE 5

Texturometry results

| Test number | Average force (mN) | grouping |
|---|---|---|
| 1 | 125 | A |
| 2 | 121 | A |
| 3 | 219 | B |
| 4 | 199 | B |

Note: Same letters are used when the means are statistically equal (95% of significance)

From visual inspection of the bread (average process) it was clear that the crumb structure of the bread with pea protein with and without TGA (Test 3 and 4) was better developed than of the bread with no pea protein, with smaller and better distributed alveolus. In addition thereto, the texturometry tests showed that the bread in test 3 and 4 had a higher crumb strength.

Visual inspection however also revealed that the bread volume was better developed in the bread with TGA and with and without pea protein (Test 2 and 4).

Overall, the bread containing both TGA and pea protein and prepared with the average process gave the best result.

The results of the tests on the process tolerance are provided in Table 6

TABLE 6

Results process tolerance tests

| | |
|---|---|
| Process conditions | Result |
| Undermixed conditions | Test 1 worse, tests 2, 3 and 4 equally best result |
| Overmixed conditions | Test 1 worse, tests 2 and 4 best result |
| Overfermented conditions | Test 1 and 2 worse, test 3 and 4 best result |
| Mechanical shock | Test 1, 2 and 3 worse, test 4 best result |

From the process tolerance tests it became clear that test 4 was the only test that provided the best result for all the process conditions tested. Addition of both TGA and pea protein thus yielded bread with the best tolerance against deviating process conditions.

So the use of a combination of pea protein and TGA in bread results not only in a better crumb structure, a better crumb strength, but also a higher bread volume and a better process tolerance.

1. Bakery pre-mix composition comprising transglutaminase, pea protein and a carrier material for the pea protein.

2. Bakery pre-mix composition according to claim 1, wherein the amount of carrier material in the bakery formulation ranges from 5-99.99% w/w, based on the total weight of the bakery formulation.

3. Bakery pre-mix composition according to claim 1 wherein the carrier material comprises material selected from the group of cornstarch, maize flour, rice flour, potato starch, cassava starch, wheat flour, maltodextrin, tricalcium phosphate, salt, calcium carbonate and silica or combinations thereof.

4. Bakery pre-mix composition according to claim 1 wherein the amount of pea protein ranges from 500 ppm to 95% w/w, based on the total weight of the bakery pre-mix composition.

5. Bakery pre-mix composition according to claim 1 wherein the amount of transglutaminase ranges from 0.05 to 5 TGU/g based on the total weight of the bakery pre-mix composition.

6. Flour formulation comprising wheat flour and the bakery pre-mix composition according to claim 1.

7. Flour formulation comprising the bakery pre-mix composition in an amount ranging from 0.01 to 20% w/w, based on the total weight of flour formulation.

8. Flour formulation comprising wheat flour, transglutaminase and pea protein.

9. Flour formulation according to claim 6, wherein the amount of transglutaminase is between 0.05 and 0.5 TGU, per 100 g flour in the flour formulation.

10. Flour formulation according to claim 6, wherein the amount of pea protein is between 100 ppm and 10.000 ppm, based on the total weight of the flour in the flour formulation.

11. Flour formulation according to claim 6 wherein the amount of wheat flour in the formulation is between 1 and 99.99% w/w, based on the total weight of the flour formulation.

12. Dough composition comprising the flour formulation according to claim 6.

13. Dough composition according to claim 12 wherein the dough comprises a liquid.

14. Dough composition according to claim 13 wherein the liquid is water and/or milk.

15. Dough composition according to claim 12 wherein the dough comprises fat, oil, butter, sugar, and/or egg.

16. Method for the preparation of a dough wherein a flour formulation according to claim 6 is combined with a liquid to form a mixture and said mixture is intimately mixed to form a dough.

17. Method according to claim 16, wherein fat, oil, butter, sugar, and/or egg is added and intimately mixed to form a dough.

18. Method for the preparation of a baked product wherein:
a. a dough composition according to claim 12 is optionally leavened, and
b. baked to form a baked product.

19. Baked product obtainable by the method according to claim 18.

20. Baked product wherein the baked product is bread.
